(19) United States
(12) Patent Application Publication
(10) Pub. No.: US 2010/0021710 A1
(43) Pub. Date: Jan. 28, 2010

(54) Antimicrobial coatings

(75) Inventors: Andrew Tye Hunt, Atlanta, GA (US); Holly E. Harris, Fairburn, GA (US); Michelle Hendrick, Winder, GA (US)

Correspondence Address: William M. Brown;nGimat Co., 5315 Peachtree Industrial Blvd., Atlanta, GA, 30341, US

(73) Assignee: NGIMAT CO., Atlanta, GA (US)

(21) Appl. No.: 12/499,507

(22) Filed: Jul. 8, 2009

Related U.S. Application Data
(60) Provisional application No. 61/078,914, filed on Jul. 8, 2008.

(51) Int. Cl. B32B 15/08

(52) U.S. Cl. 428/220; 428/336

(57) ABSTRACT

The present invention comprises the use of silver-containing nanomaterials that have reduced interaction with light and still mitigate the growth of microorganisms, including fungi. The nanolayer is sufficiently thin and can be non-continuous, so that it has nominal optical effects on the material it is formed on. Silver is combined with other elements to minimize its diffusion and growth into larger sized grains that then would have increased effects on optical properties. Preferably, the additional elements also have mitigation properties for microorganisms, but are not harmful to larger organisms, including humans. Embodiments of the present invention can be used on a wide range of substrates, used in applications such as food processing, food packaging, medical instruments and devices, surgical and health facility surfaces, and other surfaces where it is desirable to mitigate or control the growth of microorganisms.

### CROSS-REFERENCES TO RELATED APPLICATIONS

This application claims the benefit of priority of U.S. Provisional Application Ser. No. 61/078,914, filed on Jul. 8, 2008. The entirety of that provisional application is incorporated herein by reference.

### FIELD OF THE INVENTION

The present invention concerns the use of silver-containing nanomaterials that have reduced interaction with light and still mitigate the growth of microorganisms, including fungi. The nanolayer is sufficiently thin and can be non-continuous, so that it can have nominal optical effects on the material it is formed on. Silver is combined with other elements to minimize its diffusion and growth into larger sized grains that would have increased effects on optical properties. Preferably, the additional elements also have mitigation properties for microorganisms, but are not harmful to larger organisms, including humans. Embodiments of the present invention can be used on a wide range of substrates, and used in applications such as food processing, food packaging, medical instruments and devices, surgical and health facility surfaces, and other surfaces where it is desirable to mitigate or control the growth of microorganisms or pathogens.

### BACKGROUND OF THE INVENTION

A significant driver for considering antimicrobial packaging is the toll exacted by human pathogens. Indeed, the US Centers for Disease Control and Prevention (CDC) has estimated that known pathogens cause 14 million illnesses and 1,800 deaths in the US each year, while just Salmonella, Listeria, and Toxoplasma are responsible for 1,500 deaths annually in the US alone (Mead et al. “Food-Related Illness and Death in the United States,” Emerging Infection Diseases, CDC, Vol. 5, No. 5, 1999).

According to a Frost & Sullivan report, “Multidimensional functionality is the key goal in the packaging industry today . . . . Packaging is now more inclined toward aspects such as increasing shelf life, ensuring food safety through control of the environment within the package, and minimizing damage resulting from microbial attack.” (“Global Advances in Food Packaging,” Frost & Sullivan, Jun. 30, 2005). Antimicrobial additives represent a growing market, and the food and beverage industry holds the largest market share. The antimicrobial market in the European Union in 2005 was $119.7 million and is expected to reach $131.2 million in 2012 (“Use of Natural Antimicrobials Grows, Analysis Says,” Aug. 8, 2006, Foodqualitynews.com).

For plastic additives, antimicrobials ranks at the top, with fire protection, with the US, Europe, China, and other Asia-Pacific countries using more than a third of all such additives. Additional areas of high growth expected are in the food industry, pharmaceutical and chemical industries, and water disinfection. According to a report, “Antimicrobial additives and coatings will experience a high growth in the future, with new innovations, research and developments in this area. Some of the applications of these antimicrobial plastics include hospitals, public facilities, furniture and food/beverage packaging” (“The Markets for Antimicrobial Additives in Plastics Worldwide 2007-2025 Development, Strategies, Markets, Companies, Trends, Nanotechnology,” Helmut Kaiser Consultancy). For active and intelligent packaging, the expected US market in 2011 is $1.1 billion (“Active & Intelligent Packaging,” Freedonia Group, Inc., Aug. 1, 2007).

The term “nanofood” has been used to refer to food packaging applications, including antimicrobial surface coatings that use nanomaterials. This entire market increased from $2.6 billion in 2003 to $5.3 billion in 2005, and is expected to grow to $20.4 billion in 2015. The “Nano-featured food packaging” market was $1.1 billion in 2005 and is expected to reach $3.7 billion by 2010 (“Nanotechnology in Food & Agriculture?” Nano Café, Nanoscale Science & Engineering Center, The Madison Institute, University of Wisconsin-Madison, 2008). As an example, AgION's (see Table) end users make use of the AgION technology in various applications across many industries. The company has obtained both EPA and FDA approval (AgION press release, Jan. 17, 2008) and their products are listed in the US FDA/CFSAN Inventory of Effective Food Contact Substance (FCS) Notifications.

Table 1 summarizes information regarding a number of materials that are somewhat competitive with those of the present invention. Although this list is long, none of the materials rival those of the present invention. In general, the active materials are nanopowders or discrete particles that are intended for incorporation into a polymer matrix coating formulation, such as a paint or wash, or on a textile. In some cases, little detail is given regarding the material's composition or functionality. None is vapor deposited, contains the combined elements used in the present invention, is as stable, or is as inexpensive as embodiments of the present invention. The list does illustrate, though, extensive commercial interest in commercializing antimicrobial coating layers and the use of materials such as silver, copper, and zinc oxide as separate phases.

TABLE 1
Related Commercial Products

| Name | Material | Company | Description/Application |
|---|---|---|---|
| AgION ® | Silver ions in 3-D | AgION | Inorganic antimicrobial agent that |
| (Zeomic ®) | alumino-silicate | Technologies | can be used in powder form |
| | structure (zeolite) | | |
| AgActive ™ | SilverSure ™ | Healthy | Silver nanoparticles produced and |
| | process: application | Channels Pty | held in suspension in water, which |
| | of Ag nanoparticles | Ltd. | also contains silver ions. Used in |
| | to plastics and | | antibacterial sprays and |
| | textiles for bacteria, | | impregnated into fabrics. |
| | virus and fungus | | |
| | resistance. | | |
| Alesta ® AM | Made with silver | DuPont | Antimicrobial powder coatings |
| IRGAGUARD ® | Powder: silver- | Ciba | US FDA/FCN compliant for use in |
| B 5000/B7000 | based, inorganic | | all types of polymer for food |
| | antimicrobials; | | packaging application; Suppress |
| | inorganic Silver | | growth of microorganisms, mold |
| | Zeolite based or | | and mildew on the surface of |
| | inorganic Silver | | packaging materials; Designed for |
| | Glass based | | use in polymers |
| Silver Seal ™ | Soluble glass | Seal Shield | Embedded in plastic of keyboards |
| | containing | | to provide antimicrobial effect |
| | antimicrobial silver | | |
| | ions | | |
| FresherLonger ™ | Silver nanoparticles | Sharper | Embedded in plastic to provide |
| | | Image | antimicrobial effect |
| Surfacine ® | Silver | Surfacine | 3-D polymeric network |
| | | Development | impregnated with sub-micron |
| | | Company | particles of silver halide that form |
| | | LLC | silver halide/polymer complex |
| Microban ® | Technology is an | Microban | Advertised for food preparation and |
| | intrinsic part of the | International, | processing, as well as many other |
| | product built in, | Ltd. | applications |
| | inside and at the | | |
| | surface | | |
| Apacider ® | Silver-based | Sangi Co., | Additives used in plastics, textiles |
| | antimicrobials | Ltd. | |
| Zinc oxide | ZnO nanopowder | through | Advertised as possible antibacterial |
| | | Sigma | agent |
| | | Aldrich | |
| Z-MITE ™ | Zinc oxide | American | Antibacterial, antifungal, UV |
| | nanoparticles | Elements | filtering properties |
| Doped zinc oxide | Al, Cu, or Ag (ppm | Nanophase | Targeted at applications like |
| | to several %) doped | | antimicrobial agents and UV |
| | zinc oxide | | absorption |
| | nanopowders or | | |
| | nanopowder | | |
| | dispersions | | |
| Silver Zinc Oxide | Blended silver and | Umicore | For use in electrical devices such as |
| | zinc oxide powder, | | circuit breakers and relays |
| | compacted, | | |
| | sintered, extruded | | |
| DODURIT ® | Silver and zinc | AMI | For contact materials |
| | oxide powders | DODUCO | |
| Silver Zinc Oxide | Powder | Metalor | Formed into shapes for electrical |
| | | Technologies | applications |
| ACT ® T-558; | ZnO, TiO₂, or | AirQual Corp. | Antimicrobial powder |
| ACT ® Z-200 | BaSO₄ base; Ag, | | formulation-microbiocide for use |
| | Cu, or Zn active | | in commodity products |
| | ingredient; SiO₂ or | | |
| | Al₂O₃ barrier | | |
| | coating | | |
| Antibacterial | 1% nano silver | Shenzhen | For eliminating bacteria in water |
| ceramic ball | powder, 50-60% | Become | purifiers, on textiles, etc. |
| | Maifan Stone, 2.5% | Industry | |
| | zinc oxide + | Trade | |
| | additional | | |
| | ingredients | | |
| Inorganic | Powder contains | Changtai | Can be “melted” in water and |
| Antibiotic powder | silver, zinc and | Nanometer | solvents |
| | copper powders | material Co | |
| Ag/ZnO | Nano Grade Silver: | Top Nano | For application to textiles, plastic, |
| Composite | combined Ag and | Technology | etc. |
| Materials | ZnO powders | Co., Ltd. | |
| Copper(II) oxide | CuO nanopowder | through | Advertised as a possible |
| | | Sigma | antimicrobial agent |
| | | Aldrich | |
| Cupron ™ | Copper oxide as | Cupron Inc. | Permanently binds proprietary |
| | active ingredient | | copper compound to textile fibers, |
| | | | non-woven fabrics, paper, latex and |
| | | | other polymers |
| Copper oxide | Nanocrystalline | Nanophase | |
| | CuOₓ dry powder | | |
| | or dispersions | | |
| TB 6731 | Titanium oxide | Three Bond | Antibacterial with UV against |
| | photocatalyst; | Co., Ltd. | bacteria like S. aureus, P. |
| | nanosize particles, | | aeruginosa, E. coli, etc. and |
| | requires UV | | antifungal performance against |
| | exposure to be | | fungi like Candida albicans, A. |
| | active. | | niger, etc. |
| Biomaster | Composite sponge | Renaissance | Antimicrobial activity for textiles |
| | of sintered TiO₂ | Chemicals | |
| | with sparingly | Ltd | |
| | soluble AgCl | | |
| SH1000; SH2000 | Bioactive glass | SCHOTT | Intended for use as antibacterial |
| | system carrier for | | aggregate in plastics |
| | antimicrobial active | | |
| | silver | | |

Fresh fruit and vegetable shipping and marketing are very susceptible to the fragility of the product. Immediately after harvesting produce, the processes leading to breakdown begins. Careful, appropriate handling can help to slow the degradation. The rate of deterioration depends on factors such as temperature, damage, environmental moisture, and infection by decay organisms. Organism-caused decay can result from injury sites, due to attack by molds and bacteria, free water sites, water saturation, and latent infection from fungal spores. Ripened fruit can become yet more susceptible to penetration. Damaged fruit can cause premature ripening, due to increased ethylene levels. Any number of combinations of events occurring with fresh fruits and vegetables in the field and after harvest can encourage decay organisms, like mold (Harris, “Production is Only Half the Battle, A Training Manual in Fresh Produce Marketing for the Eastern Caribbean,” Food and Agriculture Organization of the United Nations, Bridgetown Barbados, December 1988). Additionally, harmful microbes can be introduced to fresh produce by farming practices and handling. Salmonella, Campylobacter, and E. coli are three bacteria commonly associated with fruit and vegetable concerns (Suslow, “Microbial Food Safety is Your Responsibility,” University of California, Vegetable Research Information Center, 2007). Although no one practice will safely address all of these microbial factors in food safety and preservation, incremental issues, like packaging, will help to prolong storage and protect against harmful microbes.

Factors food packaging experts consider include (1) container integrity, (2) antimicrobial capability, (3) ventilation requirements, (4) ability of the container material to absorb gases, (5) prevention of bruising on fresh fruits and vegetables, (6) hydration or dryness of the container, (7) environmental protection from pests, (8) toxicity of all materials, (9) ability of the container to withstand its environment, and (10) security, trace and tractability of the container and its resistance to terrorist acts. Food damage can occur during mechanical holding of the product, the heating or cooling cycle of the product, and the presence of microbes, such as bacteria, fungus, and mold, and human interaction. An understanding of health issues and spoilage has led to embodiments of the present invention that comprise silver-based antimicrobial coatings to improve food safety and increase food shelf life.

To our knowledge, there is no published article studying or directly producing a thin film or vapor-deposited compound IAN to surfaces. Some research that involves coating silver nanoparticles on other substrates include plasma-enhanced deposition of silver nanoparticles onto polymer and metal surfaces generating antimicrobial characteristics, where thin layers of silver nanoparticles are deposited onto silicone rubber, stainless steel, and paper surfaces (Jiang et al., Journal of Applied Polymer Science, Vol. 93, No. 3 (2004) 1411). The bactericidal properties of the silver-coated surfaces were tested by exposing the silver-coated silicone rubber surfaces to Listeria monocytogenes. No viable bacteria were detected after 12-18 h. Other examples of coating silver nanoparticles onto substrates, specifically fibers, include sonochemical irradiation to coat nylon-6,6 with silver nanoparticles (Perkas et al., Journal of Applied Polymer Science, Vol. 104 (2007) 1423) and layer-by-layer deposition of antimicrobial silver nanoparticles on textile fibers (Dubas et al., Colloids and Surfaces A: Physicochemical and Engineering Aspects, Vol. 289, No. 1-3 (2006) 105).

The previous coatings discussed here are either antimicrobial or antifungal, and require significant amounts of the active species, because the active species are embedded in a thick film surface ‘paint,’ or are made using expensive systems or very slow processes. Another known issue is the darkening of silver antimicrobial coatings when exposed to light and other environments that cause silver migration. Our earlier experiments of pure silver nanocoatings did darken over time with exposure to sun light. Because of these limitations and high costs, there is currently is disposable or widely used silver-based antimicrobial coating product.

Increasing interest in nanotechnology has reached the packaging industry. Although interest in nanotechnology for packaging applications includes improving package properties and biodegradability, the antimicrobial activity of nanomaterials is a prominent consideration. Silver is an agent under consideration (Chaudhury et al., Food Additives & Contaminants, Vol. 25, Issue 3 (2008) 241-258; Dillavou, “Iowa State Researchers Study Silver Nanoparticles' Potential for Improving Food Safety,” Iowa State University College of Human Sciences, Apr. 4, 2008). Nanoparticles of zinc oxide and magnesium oxide have also been considered for food packaging applications for antimicrobial and UV protection (“Nanotech discovery promises safer food packaging,” Foodproductiondaily.com, May 13, 2005; “Australian nanotech firm promises better food packaging film,” Foodproductiondaily.com, Oct. 12, 2006).

Silver is well known to have antimicrobial properties and much research has been done on it when used in nanosize form (Kim et al., Nanomedicine: Nanotechnology, Biology, and Medicine, Vol. 3 (2007) 95-101; Morones et al., Nanotechnology, Vol. 16 (2005) 2346-2353; Lok et al., J. Biol. Inorg. Chem., Vol. 12 (2007) 527-534; Sondi & Salopek-Sondi, Journal of Colloid and Interface Science, Vol. 275 (2004) 177-182; Elechiguerra et al., Journal of Nanobiotechnology, (2005) 3-6). For example, Kim et al. (Nanomedicine: Nanotechnology, Biology, and Medicine, Vol. 3 (2007) 95-101) investigated solution-prepared silver nanoparticles in solution and found growth inhibition of yeast and Escherichia coli and mild effects on Staphylococcus aureus. At certain minimum concentrations, silver nanoparticles were found to prevent growth of Pseudomonas aeruginosa, V. cholera, E. coli, and S. typhus. The mechanisms of activity against Gram-negative bacteria were identified as attachment to the membrane surface and disrupting function, penetration into the bacteria to cause damage and release of silver ions, with a bactericidal effect (Morones et al., Nanotechnology, Vol. 16 (2005) 2346-2353).

Silver has also been studied in conjunction with other materials for antimicrobial applications with positive effects, like zinc oxide (Klebsiella pneumoniae, P. aeruginosa and Staphylococcus aureus; Gehrer et al., U.S. Pat. No. 5,714,430), hydroxyapatite (E. coli, P. aeruginosa, S. aureus, Staphylococcus epidermidis), brown-rot fungus (Fomitopsis palustris) and white-rot fungus (Trametes versicolor; Feng et al., Thin Solid Films, Vol. 335 (1998) 214-219; Haruhiko et al., Journal of Antibacterial and Antifungal Agents, Vo. 31, No. 2 (2003) 69-76) titanium oxide (Gram-negative non-fermentative bacteria and fungi; Corbett, International Journal of Cosmetic Science, Vol. 18, Issue 4 (1996) 151-165), silicon oxide (E. coli; Height & Pratsinis, WO 2006/084390; Height, European Patent EP 1 889 810; Mangold & Golchert, US Pat. Application US 2003/0235624), iron oxide (E. coli, S. epidermidis, Bacillus subtilis; Gong et al., Nanotechnology, Vol. 18 (2007)), molybdates (E. coli, S. aureus; Meng & Xiong, Key Engineering Materials, Vols. 368-372 (2008) 1516-1518), and organics (S. aureus, S. epidermidis, P. aeruginosa, E. coli, Enterobacter aerogenes; Zaporojtchenko et al., Nanotechnology, Vol. 17 (2006) 4904-4908; Falk, “Preservation of Coatings with Silver,” Clariant Products, GmbH Frankfurt, Germany, presented at the Numberg Congress held during the European Coatings Show, Nurnberg, Germany, May, 2007), as well as in so-called “bioactive glasses” (E. coli, P. aeruginosa, S. aureus, enterococci; Bellantone et al., Antimicrobial Agents and Chemotherapy, Vol. 46, No. 6 (2002) 1940-1945; Waltimo et al., J. Dent. Res., Vol. 86(8) (2007) 754-757; Verne et al., Biomaterials, Vol. 26, Issue 25 (2005) 5111-5119).

Copper and copper oxide are also known fungicidal and antimicrobial materials. Copper and copper alloys have been found to be effective against E. coli, Streptococcus, Staphylococcus, methicillin-resistant S. aureus and black mold or Aspergillus niger (“Anti-microbial Characteristics of Copper,” ASTM Standardization News (October, 2006) 3-6). It is well known as an antifungal agent (Borkow & Gabbay, Current Medicinal Chemistry, Vol. 12 (2005) 2163-2175). Commercial copper-based products are marketed.

Zinc oxide is another studied antimicrobial material of commercial interest. ZnO has been added to paper for antibacterial effects against E. coli (Ghule et al., Green Chem., Vol. 8 (2006) 1034-1041). The results are consistent with the antimicrobial action being related to hydrogen peroxide generated from the ZnO under specific limited conditions. Other researchers have also investigated ZnO's effects against E. coli, Klebsiella pneumoniae, and S. aureus (Jun et al., Journal of Antibacterial and Antifungal Agents, Vol. 31, No. 1 (2003) 1-6; Zhang et al., Journal of Nanoparticle Research, Vol. 9, No. 3 (2007) 479-489; Vigneshwaran et al., Nanotechnology, Vol. 17 (2006) 5087-5095).

Preferred embodiments of the present invention use compositions containing Ag, Cu and/or ZnO as compounds or alloys. Ag and ZnO composites are known and used in electrical contact materials, low-emissivity coatings, and photocatalytic applications (Zhang & Mu, Journal of Colloid and Interface Science, vol. 309 (2007) 478-484; Height et al., Applied Catalysis B: Environmental, Vol. 63 (2006) 305-312; Ando & Miyazaki, Thin Solid Films, Vol. 351 (1999) 308-312; Wang et al., Key Engineering Materials, Vols. 280-283 (2005) 1917-1920; Schoept et al., Components and Packaging Technologies, IEEE Transactions, Vol. 25, Issue 4 (December 2002) 656-662). They have also been investigated for antimicrobial applications, where S. aureus, E. coli, and Candida albicans were killed or inhibited (Zhou et al., Materials Science Forum, Vols 486-487 (2005) 77-80).

The history of antimicrobial inorganic materials is extensive. The application method of these materials is surprisingly uniform, typically involving ‘painting’ or laminating active materials in the form of powder suspensions that are then incorporated onto the product, through the use of common applicants, like sprays and coatings, or embedding in polymers. Given the history of research into materials comprising silver, copper, and/or zinc oxide as well as many more elements show such materials have promise as antibacterial and antifungal agents. Many have worked in this application area, but none has addressed the issues of the optical effects of the coating, adhesion, light stability, and very low quantities of the active material.

### BRIEF DESCRIPTION OF THE FIGURES

FIG. 1. Schematic of the thin-film NanoSpray CCVD process.

FIG. 2. STEM micrograph of CCVD nano-Ag directly deposited onto sample grid.

### DESCRIPTION OF THE INVENTION

Potential applications of the coatings of the present invention are numerous. One commercial application for the IANs of the present invention is disposable packaging for fresh fruits and vegetables.

Embodiments of the present invention address improved health safety for disposable food packaging that can also increase the shelf life of the food. Coatings of the present invention may be applied to any surface that may come in contact with food or drink, directly or indirectly. An example of indirect contact would be processing fluids that contact surfaces that the food or drink also touches. Food contact surfaces can be functionalized with the inorganic antimicrobial/antifungal nanocoatings (IANs) of the present invention. Such coatings can be formed using, for example, the combustion chemical vapor deposition (CCVD) process, and comprise a combination of metal(s) and/or metal oxide(s) as a compound, applied in one step, directly to the surface to be protected. Another important factor is the coatings deposited by CCVD or other vapor methods have very high bonding to the surface so that they are not easily removed. The coating becomes one with the substrate and does not wash or blow away as nanoparticles.

The CCVD-deposited materials are applied on a nanometer scale to increase their efficiency, to nominally affect light transmission or reflectance, and also to reduce the materials cost. Indeed, in some embodiments of the present invention, a realistic cost can be of the order of several US cents per square foot, making it feasible for disposable container applications and taking advantage of the increased surface area provided by nanoscale materials. Embodiments of the present invention provide an attractive, cost-efficient, antimicrobial surface that can reduce the likelihood of human pathogens and molds collecting on contact surfaces and can increase the storage life of fresh fruits or vegetables.

Such highly transparent, stable, antimicrobial nanocoatings have not previously been achieved. Typically, other antimicrobial technologies use particle embedding or impregnation, normally in a polymer, which ensures adhesion, but requires significantly more material, such as silver. This also decreases light transmission significantly, and increases the quantity of material needed, compared with the surface nanocoatings of the present invention. When these composite coatings are abraded, chunks of the silver in the polymer can be removed and the nanosilver composite can enter, for example, the food or drink concerned or the environment generally, which is a concern of government agencies.

The amount of material necessary for sufficient antimicrobial activity must be so small that the effect on food cost is negligible, especially when considering one of the components, silver, which is a relatively costly material in bulk. For the IAN to remain effective, it must stay in place, despite contact with moisture and/or food/produce rubbing against it. Over time, the silver and other elements should release their constituent ions, which can then interact with nearby microbes and fungi. This release will be very slow, so there will only be an effect on or near the coated surface in most cases. By the time fluid flows away into any volume of dilution the concentration of ions would be near that occurring in nature and no longer represent a threat to any life form. This is an environmental strength of using a well-bonded surface nanolayer in embodiments of the present invention.

In all industries, cost is a factor; in the packaging industry, especially, the cost per package can be a few US cents, and providers can be switched for a penny difference. This is because typically there is no performance difference. However, people do care about their health and companies care about health-related liability and image. The reasonably priced, transparent IANs of the present invention will be of value in the packaging industry, with a low cost because so little silver is used.

Elements in the coatings of the present invention include silver (Ag), and others, preferably copper (Cu) and/or zinc (Zn), as metals and/or oxides. These can be applied by combustion chemical vapor deposition (CCVD), or other processes, directly to the substrate. The substrate can be of almost any solid, including polymers, such as PET (polyethylene terephthalate), as a coating without any organic binder, adhesives, or post-deposition processing. Other elements can be included with the primary Ag, Cu, and/or Zn components, as these do not have to be of high purity to be effective. The CCVD technique, described in U.S. Pat. No. 5,652,021, included herein by reference, used to deposit the coatings is unique, and allows for the use of low-cost soluble precursors and ambient processing, without a reaction chamber.

Embodiments of the present invention comprise the making of one or more compounds or alloys containing Ag, Cu, and/or Zn for use in making an inorganic thin-film coating less than 100 nm thick and preferably less than 20 nm thick. Another embodiment of the present invention comprises the non-vacuum application of antimicrobial coatings without the use of polymers or other application media, preferably by the CCVD technique.

Embodiments of the present invention comprise directly applying a largely transparent nanolayer of two- or three-component antimicrobial materials to a surface without organic or adhesive additives or embedding in a polymer. This innovation allows uninhibited contact of the antimicrobial(s) with the surroundings, such as fluids or solids, such as fruit or vegetables. All of the antimicrobial material is accessible, rather than being embedded; such embedding can result in much of the antimicrobial material being isolated. As a result, substantial reductions in quantities of active antimicrobial material can be achieved, compared with embedding or other means of incorporation. For example, to make this concept yet more economically attractive, an unformed plastic sheet can be coated prior to molding into a container.

In another embodiment of the present invention, the materials can be deposited from a flame (by CCVD), so any additional heat from the molding process should have no significant effect on them. Because the antimicrobial materials are exposed on a surface, they must be adherent to avoid loss of material, through mild abrasion and/or exposure to fluid flows. Additionally, the materials are stable and not easily physically or chemically changed over time by light or atmospheric exposure, a necessary property to consider because of silver's propensity for migration under varying circumstances. As fresh fruit and vegetable packaging become part of a consumer product, appearance is an important consideration, as is cost.

The IANs of the present invention can be deposited, for example, using nGimat's NanoSpray^{SM} combustion processing CCVD technology. This is a technique for forming thin films and coatings of various compositions. CCVD is an effective means of creating the innovative IANs of the present invention. Without using CCVD, low-cost IAN deposition directly onto plastic in the open air would be difficult, but other thin film technologies are available that may suitable for doing this.

The key advantage of the CCVD coating process is the ability to use it to deposit thin films in the open atmosphere, using inexpensive precursor chemicals in solution. This removes the need for costly furnaces, vacuum equipment, reaction chambers, and post-deposition treatment, such as annealing. As a result, capital requirements and operating costs are reduced substantially when compared with competing vacuum-based technologies, such as sputtering and MOCVD. The ability to deposit thin films in the open atmosphere enables continuous, production-line manufacturing or portable systems that can coat equipment, physical plant, and structures. As a result, throughput potential is far greater than with conventional thin film technologies, most of which are generally restricted to batch processing.

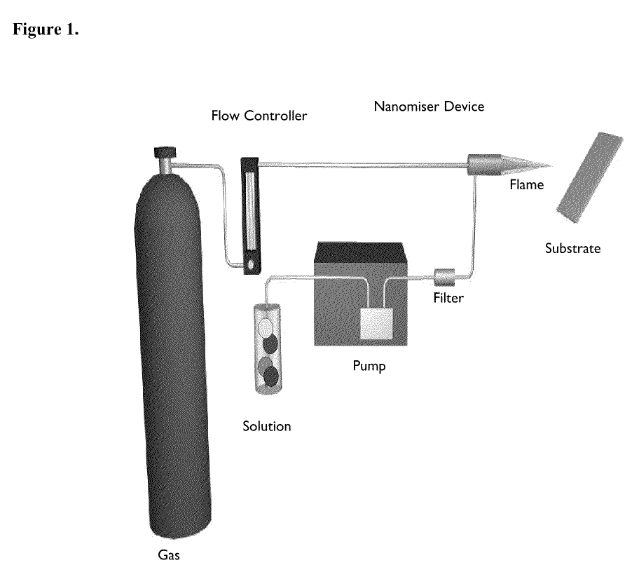

In the NanoSpray combustion technology, precursors, such as low-cost metal nitrates or 2-ethylhexanoates, are dissolved in a solvent, which typically also acts as the combustible fuel. This solution is atomized to form submicron droplets, and these nano-droplets are then conveyed by an oxygen-containing stream to the flame where they combust in a manner similar to a premixed gas fuel (NanoSpray Combustion Process). In CCVD of the IANs of the present invention, the substrate is coated by simply drawing it across the flame plasma, as shown schematically in FIG. 1.

Although the deposited materials are referred to as a “coating,” the actual deposit may not end up looking like a continuous layer. Depending on the temperature, amount of material, and final composition of the coating, the IAN is expected to deposit more as discrete “islands” of material. This is the case for many vapor deposition processes, which start with an island nucleation center that grows into continuous layers if enough material is deposited. The stretching process of the substrate would seem to be expected to cause flaking of the coating due to cracking and delamination.

A nanofilm (˜5-20 nm), such as those of the present invention, can undergo much more bending than a thicker coating. Stretching could indeed potentially cause cracking, but it may not cause associated delamination because of the size scale. Stretching can be almost unlimited when the IAN is still structured as discrete islands. As long as the deposit remains adherent, continuous or not, it will continue to function as an antimicrobial after stretching as it did before stretching. If adherence becomes a problem after forming, then the structure of the deposit can be modified as necessary.

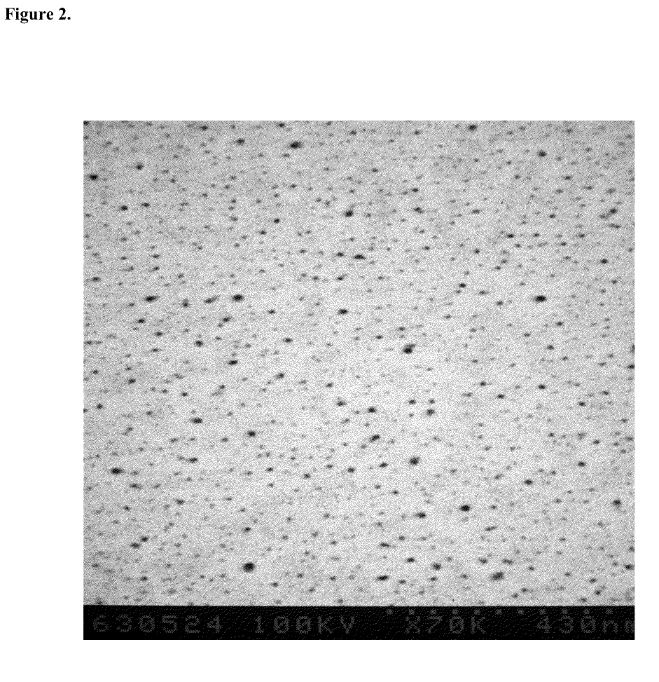

Generally, the IANs of the present invention are not deposited as a dense coating, but instead are made up of tiny islands attached to the substrate, which minimizes amount of material while providing high exposed surface area. The silver-containing material can be deposited as discrete islands, as shown in FIG. 2, in which the material was deposited directly onto a TEM grid. Substrate temperature is an independent process parameter that can be varied to actively control the deposited film's microstructure. Although flame temperatures are usually in excess of 800° C., the substrate may dwell in the flame zone only briefly, thus remaining cool (<100° C.). Alternatively, the substrate can be either allowed to increase in temperature or be readily cooled in the open atmosphere. The CCVD process for thin film deposition is not line-of-sight, and can produce coatings with an orientation from preferred to epitaxial, and can produce conformal layers less than 10 nm thick. The IANs of the present invention can be a continuous coating or can consist of islands.

The CCVD technique is as a true vapor deposition process for making thin-film coatings. For comparison, Ag—Zn particles have previously been produced by spray pyrolysis, but the starting materials consisted of ZnO powders and a silver source, like silver nitrate, so that the end material was not an intimate mixture, alloy, or compound, but separate phases (Kang & Park, Materials Letters, Vol. 40 (1999) 129-133; Kieda, Key Engineering Materials, Vols. 264-268 (2004) 3-8). In another study, Zn and Ag precursors were mixed and reacted in a flame spray pyrolysis to form a thick layer of ZnO with Ag particles formed on their surface (Perkas et al., Journal of Applied Polymer Science, Vol. 104 (2007) 1423). Particles of silica with silver and possibly other materials like copper and ZnO have also been introduced. However, there is no previous report of nanomaterials such as the IANs of the present invention involving intimate mixtures of compounds, nor were they vapor-deposited directly as nanocoatings.

Preferred embodiments of the present invention use the materials silver, copper, and/or zinc, because they are known to be effective biocides or growth inhibitors of a wide range of bacteria and fungi, but are also safe to humans. Embodiments of the present invention affect not only human pathogens, but also naturally occurring microbes that contribute to the decreased shelf life of packaged food products. Inorganic silver, copper, and zinc as separate materials in different forms have previously received FDA approval for food contact. All three elements in separate forms are also used in dietary supplements for human consumption. By using a nanocoating, the amounts of material involved will be considered trace levels, compared with that contained in the contained food or produce.

In preferred embodiments of the present invention, the combination of two or three elements as compounds provides a more comprehensive coating structure, capabilities, and stability. Silver, primarily, and to a lesser degree, copper, are known antimicrobial agents, with copper often being given more consideration for molds and fungi. Zinc oxide is also known to be antimicrobial, but its use here is directed more at stabilizing the silver deposit from migration and secondarily as an anti-pathogen. When compounds or alloys are made, the performance of these usually differ significantly for the individual elements. The present invention involved the characterization of the elements that could be used to achieve all the desired effects and properties.

Coatings of the present invention are adherent. Because of an adherent coating, less material is lost from the surface or container, onto, for example, the fluids or food in contact with the container.

In another embodiment of the present invention, the nanolayers can be beneficially formed on multi-person skin contact substrates. Such coatings can help reduce transmission of disease agents from one person to another. Such surfaces include, but are not limited to, door handles, stair rails, rental car components, health facility equipment, security screening areas, restaurants, writing devices, bathroom fixtures, and shopping carts. Using the CCVD process, such items can be made initially with a coating or they can be coated in place, with a portable CCVD system.

### EXAMPLES

Microbe tests were performed on Petri dishes coated with example IANs of the present invention and the results showed at least a 99.5% reduction in microbes on the surface. These tests were performed by depositing different ratios of Ag, Zn, and Cu (refer to solution variations A, B, C, with A being 50% Ag and 50% Zn, B being ⅔ Ag and ⅓ Zn, and C being ⅓ each of Ag, Zn, and Cu, with all being oxalates in THF) with different amounts of material (refer to lap column, with higher number reflecting more material). The Code column is the sample ID with C# being the same surface without IAN (control result). For antimicrobial testing, standard plating procedures were followed from the AOAC methods in the FDA/BAM Manual.

| | | Cell Count | | | % Reduction | | | | |
|---|---|---|---|---|---|---|---|---|---|
| Microbe | Code | 15 min | 1 h | 2 h | 15 min | 1 h | 2 h | Solution | Laps |
| Salmonella | WI48A1 | <10 | <10 | <10 | N/A | N/A | N/A | A | 12 |
| | WI48C1 | 30 | <10 | <10 | 99.999 | 99.999 | 99.999 | A | 24 |
| | WI49B1 | <10 | <10 | <10 | 99.999 | 99.999 | 99.999 | B | 12 |
| | WI49D1 | 300 | <10 | <10 | 99.999 | 99.999 | 99.999 | C | 24 |
| | C1 | 8,700,000 | 9,400,000 | 9,300,000 | N/A | N/A | N/A | N/A | 0 |
| Listeria | WI48A2 | 25,000 | <10 | <10 | 99.75 | 99.999 | 99.999 | A | 12 |
| | WI48C | 2,100 | <10 | <10 | 99.979 | 99.999 | 99.999 | A | 24 |
| | D1 | | | | | | | | |
| | WI49B2 | 5,300 | <10 | <10 | 99.975 | 99.999 | 99.999 | B | 12 |
| | WI49D2 | 44,000 | <10 | <10 | 99.56 | 99.999 | 99.999 | C | 24 |
| | C2 | 10,000,000 | 11,000,000 | 14,000,000 | N/A | N/A | N/A | N/A | 0 |
| E. coli | WI48B1 | <10 | <10 | <10 | 99.999 | 99.999 | 99.999 | A | 12 |
| | WI48D2 | <10 | <10 | <10 | 99.999 | 99.999 | 99.999 | A | 24 |
| | WI49C1 | <10 | <10 | <10 | 99.999 | 99.999 | 99.999 | B | 12 |
| | WI49E1 | 470 | 10 | <10 | 99.999 | 99.999 | 99.999 | C | 24 |
| | C3 | 7,400,000 | 7,600,000 | 8,500,000 | N/A | N/A | N/A | N/A | 0 |

In the next set of examples, the lap numbers were reduced, to as few as one lap. Further modifications were made to the IAN solution formulation as shown in the solution column. The concentrations and ratios of Ag, Cu and Zn precursors (nitrates and oxalates from 10 to 100 mM) were varied, in addition to a change in the base solvent (alcohols and refined solvents) and solvent additives used. Variant D was 50% Ag and 50% Zn, and E, F, and G were ⅓ each of Ag, Zn, and Cu. D, E, F, and G are all nitrate precursors in methanol and/or acetonitrile. The examples are not limiting to the breadth of the innovation, as wider ranges can be effective. It is desirable to have at least 20% Ag and at least 20% Zn. The solution preferably comprises nitrates, dissolved in a solvent of mostly alcohol, which is inexpensive and was found to be stable and easy to use when performing NanoSpray Combustion CCVD. After 2 h, the % reduction in microbes was 99.99% for all samples, compared with the control (C1, C2, C3).

The motion of the flame relative to the substrate can range widely and depositions have been successfully made from 1 to 30 m/min. The faster the motion, then the closer the flame can be without damaging heat-sensitive substrates. For example, flow rates can be from about 1-10 mL/min per flame or larger if needed, and 1-5 flames have been run together, but more could be used. The flame can be directed at the substrate or deposition gasses can be cooled and directed at the substrate using a secondary gas or air flow, as illustrated in U.S. Pat. No. 7,351,449.

| | | Cell Count | | | |
|---|---|---|---|---|---|
| microbe | Code | At 2 h | % reduction | Solution | Laps |
| E. coli | WI 71A1 | <1 | 99.999 | D | 3 |
| | WI 71C1 | <1 | 99.999 | D | 6 |
| | WI 71E1 | <1 | 99.999 | E | 3 |
| | WI 71G1 | <1 | 99.999 | E | 6 |
| | WI 72A1 | <1 | 99.999 | F | 3 |
| | WI 72D1 | <1 | 99.999 | G | 1 |
| | WI 72F1 | <1 | 99.999 | G | 3 |
| | WI 72H1 | <1 | 99.999 | G | 6 |
| | WI 73A1 | <1 | 99.999 | G | 9 |
| | WI 73C1 | <1 | 99.999 | G | 12 |
| | C1 | 14,000,000 | N/A | N/A | 0 |
| Listeria | WI 71A2 | 16 | 99.999 | D | 3 |
| | WI 71C2 | 87 | 99.999 | D | 6 |
| | WI 71E2 | 33 | 99.999 | E | 3 |
| | WI 71G2 | 16 | 99.999 | E | 6 |
| | WI 72A2 | 290 | 99.999 | F | 3 |
| | WI 72D2 | 500 | 99.998 | G | 1 |
| | WI 72F2 | 190 | 99.999 | G | 3 |
| | WI 72H2 | 11 | 99.999 | G | 6 |
| | WI 73A2 | 160 | 99.999 | G | 9 |
| | WI 73C2 | 3 | 99.999 | D | 12 |
| | C2 | 31,000,000 | N/A | N/A | 0 |
| Salmonella | WI 71B1 | <1 | 99.999 | A | 3 |
| | WI 71D1 | <1 | 99.999 | A | 6 |
| | WI 71F1 | <1 | 99.999 | B | 3 |
| | WI 71H1 | <1 | 99.999 | B | 6 |
| | WI 72B2 | <1 | 99.999 | C | 3 |
| | WI 72E1 | 18 | 99.999 | D | 1 |
| | WI 72G2 | <1 | 99.999 | D | 3 |
| | WI 72I1 | <1 | 99.999 | D | 6 |
| | WI 73B1 | <1 | 99.999 | D | 9 |
| | WI 73D1 | <1 | 99.999 | D | 12 |
| | C3 | 18,000,000 | N/A | N/A | 0 |

The deposition time can be further reduced by increasing the solution flow rate (or increasing the amount of material that reaches the substrate per unit time) or by changing the process configurations. The more preferred concentrations ranges for most CCVD solutions are from 5 mM to 100 mM. The concentrations in the examples ranged from 12 to 25 mM.

A wide range of substrates has been coated with coatings of the present invention including various plastics, natural fibers, metals, ceramics, and composites. To ensure good bonding the surface is first cleaned of any residues and dirt, and is dry when vapor coating.

All documents, books, manuals, papers, patents, published patent applications, guides, abstracts and other references cited herein are incorporated by reference in their entirety. Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A surface nanolayer of less than 100 nm thickness material containing silver, along with at least one of copper or zinc, wherein the nanolayer has antimicrobial properties.

2. The material of claim 1 that contains both copper and zinc with the silver.

3. The nanolayer of claim 1 formed by a vapor deposition process.

4. The nanolayer of claim 1 formed by the CCVD process from precursors in a liquid solution.

5. An article comprising the nanolayer of claim 1 adheringly disposed on a plastic substrate.

6. An article comprising the nanolayer of claim 1 formed on a food packaging plastic substrate.

7. An article comprising the nanolayer of claim 1 formed on a medical substrate.

8. An article comprising the nanolayer of claim 1 formed on a food service or processing substrate.

9. An article comprising the nanolayer of claim 1 formed on a multi-person skin contact substrate.

10. An article comprising the nanolayer of claim 1 where the effect on the visible spectrum is less than 30%.

11. An article comprising the nanolayer of claim 1 where the effect on the visible spectrum is less than 15%.

12. An article comprising the nanolayer of claim 1 where the effect on the visible spectrum is less than 8%.

13. The nanolayer of claim 1 where the average film thickness is less than 20 nm.

14. The nanolayer of claim 1 where the average film thickness is less than 10 nm.

15. The nanolayer of claim 1 where the film is not continuous.

16. The liquid solution to form the material of claim 4 composed of metal nitrates in a solvent.

17. The liquid solution of claim 16 with processing concentration of 5 to 100 mM in a solvent of mostly alcohol.

18. The nanolayer of claim 1 containing no organic binding agents.
